(19) United States
(12) Patent Application Publication
(10) Pub. No.: US 2004/0264750 A1
(43) Pub. Date: Dec. 30, 2004

(54) Facial ruler device, method and kit

(75) Inventors: Alexander Paul Znaiden, Trumbull, CT (US); Tomoko Kurita, Togishi 329-1311 (JP); Tamiko Yamamoto, Saitama 338-0001 (JP); Yoshiharu Ashizawa, Saitama 330-0804 (JP); Helen Elizabeth Knaggs, Weehawken, NJ (US); Srinivasan Krishnan, Union City, NJ (US); Kathy Anne Lanza, Towaco, NJ (US); Robert Paul Velthuizen, Livingston, NJ (US)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/606,390

(22) Filed: Jun. 26, 2003

(51) Int. Cl. G06K 9/00

(52) U.S. Cl. 382/128

(57) ABSTRACT

A pore ruler for objectively measuring attributes of facial skin pores and methods of using same. The pore ruler device includes a scale having indicia of at least two different pore attributes captured in a medium, determined by the following steps:

(i) Taking multiple photographs of multiple subjects;

(ii) Sorting the photographs, thereby classifying them according to said pore attributes to obtain sorted data;

(iii) Analyzing said sorted data;

(iv) Selecting representative images from each bin, thereby creating a pore ruler scale; and

(v) Validating said pore ruler scale by clinicians and consumers to show that consumers can distinguish pore attributes and correlate them with said scale.

A cosmetic product system is also provided which includes a cosmetic composition for reducing the appearance of facial skin pores, and a pore ruler device packaged with the composition. A method for assessing pore attributes on the pore ruler scale, as well as of evaluating progress of the combat against the signs of pores occurring over a period of time within which the composition is applied to an area of skin being monitored is provided.

### BACKGROUND OF THE INVENTION

1. Field of the Invention

The invention concerns a facial ruler, method of using the ruler, and a ruler device packaged with a composition to form a kit for measuring and reducing the appearance of facial pores or wrinkles, and for demonstrating proof of efficacy or facilitating product selection.

2. The Related Art

The ultimate goal of a cosmetic composition for reducing the appearance of pores, as well as that of any cosmetic product or method, is a satisfied consumer. Many cosmetic products advertise facial pore benefits. While expert graders may be trained to use diagnostic equipment or to visually perceive the difference, consumers usually cannot easily discern whether the claimed benefit is actually delivered, or a quantitative extent to which it is delivered.

A number of publications have disclosed test devices for experts to diagnose skin conditions. These include U.S. Published patent application No. 2002/0181752 disclosing measuring changes in portions of a human body by three-dimensional images that are taken and superimposed,

http://home.earthlink.net/˜sbdarnell/pore_size.htm where pore size is measured using a magnified projection image to provide a measurement of pore diameter;

http://www.dermawand.com/derma_wand_clinical_study.htm where digital photographs are taken and electronically transmitted to a technician for evaluation.

Phillips et al., “Efficacy of 0.1% Tazarotene Cream for the Treatment of Photodamage,” Arch Dermatol, vol 138, p1486-1493 (November 2000) describes a 5 point scale (0:barely visible-4-large) noticeable to patients and investigators.

Consumer self-assessment of pore size is described in Bitter, Dermatol Surg, vol 26, p835-843 (2000), however no scale is defined.

A scale for evaluating wrinkles is disclosed in Tuskahara et al., “A Photographic Scale for the Assessment of Human Facial Wrinkles,” J. Cosmet. Sci., 51:127-139 (March/April 2000). However, no objective scale for evaluating facial pores has been reported.

Accordingly, there is a need for a tool for the objective visual measurement of attributes of human facial skin pores, as well as wrinkles and other facial attributes. Applicants have developed a ruler device, system, and methods that (1) can be used as a clinical tool to evaluate the efficacy of pore or wrinkle reducing products, (2) as a consumer tool to determine the degree of change that is meaningful and ideal to the consumer, (3) as a consumer clinical tool to measure the effectiveness of products from a consumer and clinical perspective, and (4) as a point of purchase device to allow a consumer a simple method to evaluate before and after treatment changes in size of pores or wrinkles. The ruler provides the ability to define the distribution of pore or wrinkle size in a specific population, set technical and consumer targets, and allows the consumer a simple method to measure the effect.

### SUMMARY OF THE INVENTION

The present invention provides a tool that meets the need for objective visual assessment of attributes of facial skin pores, wrinkles, and other attributes. The ruler is a collection of at least two, preferably about 8 to about 15, more preferably about 9 to about 10 (based on ability to discriminate between grades), representative facial photographs that capture the scope and nature of human facial attributes. A pore ruler device comprising a scale having indicia of at least two different pore attributes captured in a medium, determined by the following steps:

(i) Taking multiple photographs of multiple subjects;

(ii) Sorting the photographs, thereby classifying them according to said pore attributes to obtain sorted data;

(iii) Analyzing said sorted data;

(iv) Selecting representative images from each bin, thereby creating a pore ruler scale; and

(v) Validating the pore ruler scale by clinicians and consumers to show that consumers can distinguish pore attributes and correlate them with the scale.

Another embodiment of the present invention is a Wrinkle Ruler, made by the steps outlined above, and focusing on facial wrinkles, especially the under eye and/or the crow's feet area of the face. In other embodiments, other facial attributes may applied.

Among possible facial ruler devices are those where the medium on which the facial ruler scale is embodied is the Internet, camera, palm pilot, mobile phone; mobile camera phone, advertising and promotional material, including television, magazines, brochures, posters, flyers, and hand-outs; and/or water-insoluble substrate. Water-insoluble substrate includes a strip, a double strip, or a sliding ruler alone or in combination with a mirror or other reflective surface. Water-insoluble substrate may be made from a material including cellulosic, plastic, mirror or combination material.

A cosmetic product system is provided which includes:

(i) a cosmetic composition for reducing the appearance of undesired facial attributes is housed in a package; and

(ii) facial ruler device associated with said package;

the device having a means for evaluating current appearance of facial attributes, such as pores or wrinkles, or progress in reducing the appearance of facial pores or wrinkles with the use of the cosmetic composition. The facial ruler device comprises a scale having indicia of at least two different pore or facial attributes captured in a medium as described above.

Where the medium is a strip, it may be placed into a carton alongside a container holding the cosmetic composition or may be incorporated as a panel segment of a carton protectively surrounding a container holding the cosmetic composition or may be detachably joined to a carton protectively surrounding a container holding the cosmetic composition, such as by joinder through a means such as perforations, weakened carton wall and adhesive joinder.

Further, there is provided a method for evaluating attributes of pores or wrinkles on an area of facial skin and/or the efficacy of a cosmetic product for reducing the appearance of facial pores or wrinkles, including:

(A) providing a kit which comprises the system as described above;

(B) applying the cosmetic product to the skin;

(C) placing the facial ruler device against the skin treated with the cosmetic product in step (B);

(D) visually assessing a score on the facial ruler scale; and

(E) repeating steps (C) and (D) at a future time followed by comparison of scores resultant from first and second assessments of the skin.

The evaluation is advantageously a self-evaluation by a consumer or an evaluation by a clinician, beautician or sales assistant.

### BRIEF DESCRIPTION OF THE DRAWINGS

Although not limited thereto, additional objects, features and benefits of the present invention will become more readily apparent from consideration of the drawings in which:

FIG. 1 is a representation of a pore ruler scale according to one embodiment of the present invention;

FIG. 2 is a first embodiment of a pore ruler device according to the present invention, i.e., as a strip;

FIG. 3 is a second embodiment of a pore ruler device according to the present invention, i.e., a double strip;

FIG. 4 is a third embodiment of a pore ruler device according to the present invention, i.e., a ruler adjacent a mirror; and

FIG. 5 is a fourth embodiment of a pore ruler device according to the present invention, i.e., a ruler with a double mirror.

### DETAILED DESCRIPTION OF THE INVENTION

Now consumers have been provided with a test device for objectively determining facial attributes, such as skin pore or wrinkle condition and/or measuring progress on efficacy of the cosmetic composition over a period of its application. The ruler is a collection of at least two, preferably about 8 to about 15, more preferably about 9 to about 10 (based on ability to discriminate between grades), representative facial photographs that capture the scope and nature of human facial attributes, such as pores, wrinkles, photodamage, and the like. A cosmetic product system is also provided, including a cosmetic composition packaged together with a simple diagnostic ruler device.

The ruler device is based on the establishment of a clinical grading scale relevant to consumer perception. Accordingly, the ruler device of the present invention is a consumer perceivable, clinically usable tool for the assessment of facial pores or wrinkles. It may be applied for consumer self-evaluation or for evaluation by a beautician or sales associate.

As used herein, skin pores are defined as openings or troughs on the skin surface. More particularly, a pore is an opening for a sebaceous oil gland and for hair. Pores are microscopic openings in skin that provide a way for oil or sebum to lubricate and protect the skin surface. Glands enlarge during puberty and there is a concomitant increase in the amount of oil produced. Consumers report that their pores get bigger to handle the increased output, although the true mechanisms controlling pores remain unknown at present. The overall appearance of pores depends on the depth and diameter of the troughs as well as on the surrounding skin color, texture and periodicity of the pores.

Scale

The present invention is based on an empirically derived scale for objectively assessing attributes of pores on an area of human skin. Using the same inventive procedure, a scale for other facial attributes, such as wrinkles and photoaging, may be developed. The following steps were taken to develop the ruler scale, and each will be discussed in more detail hereinbelow:

1. Photography

2. Sorting

3. Analysis of Sorted Data

4. Selection of Images

5. Validation of Draft Ruler by Consumers

### 1. Photography

About 100 Japanese female subjects were photographed using a digital camera under controlled lighting conditions and using the same camera settings. The women were asked to remove their facial makeup before being photographed. The photos were obtained in 3 views, the left, front and right views of each subject. The digital images were then burnt on a CD-R and consistently printed on A4 size photo paper on the Codonics® colour printer. The settings on the printer were optimised to closely match the colour of the images when viewed on a BARCO® calibrated colour monitor. Other printers, such as Epson MC-5000 printer, may be used as long as all photographs are consistently printed on the same printer with the same settings.

The subjects were photographed in duplicate in each position.

The important points to be noted at this stage of the process are given below:

1. Choose optimised camera set-up that includes lighting, camera and camera settings.

2. Subject orientation: Position all subjects in a reproducible manner.

3. Print in consistent way ensuring that the printed images are “life” size and correct color. Any color printer is suitable as long as the same one is used throughout the exercise.

It is preferable to grey out the eyes to eliminate possible identification of the subjects.

### 2. Sorting

The about 100 printed photographs were placed into 9 bins by evaluators both in the United States as well as in Japan in increasing order of perceivable pore size or “pores standing out”. There were 6 evaluators in the U.S. and 3 in Japan who participated in this exercise and it took about 1.5 to 3 hours per evaluator to complete the exercise. The evaluators adopted one of many ways to achieve the sorting. Whereas a few evaluators started off by splitting the stack into 3 bins (i.e.) low, medium and high, before further classifying each of the bins until they arrived at the final result of 9 bins. Other evaluators began by identifying the extremes in condition of perceivable pore size, and then worked their way through the middle. Irrespective of the method adopted, the evaluators were always instructed to end up with 9 pore bins that were representative of differences in perceivable pore size. In addition, the evaluators were also asked to identify one single photograph per bin that was most representative of the images in that bin.

### 3. Analysis of Sorted Data

About 90% of the evaluators were in agreement among themselves within one “pore bin”. The next step in the development of the ruler is the selection of images.

### 4. Selection of Images

The selection of images for the ruler consisted of the following steps:

1. Select “representative” images out of each bin to form a draft ruler.

2. Attain high agreement (low standard deviations) as to the selected images across the different evaluators.

3. Select those images that provide equal steps between neighboring bins.

4. Iterate between Japanese and U.S. graders until agreement is reached.

The pore ruler images capture a range of conditions in facial pores that are representative facial pores of the Japanese consumers. Although there were only 9 bins, in order to satisfy criteria 3, the pore ruler may consist of 10 images, or more. Although pores are specifically referenced in this procedure, a scale may be derived for other facial attributes using the steps described herein. Such a scale is applicable for wrinkles, signs of photoaging, acne, oily skin condition, and other facial attributes.

### 5. Validation of Draft Ruler

The next step in the development of the ruler was the validation of the draft ruler by consumers. This involved two steps. The first step was the validation of the ruler by clinicians. The results from this validation showed that the rank ordering of the pore ruler images by the clinicians is the same as that of the graders both in Japan and the U.S. The results also showed that the draft ruler is consumer perceivable ruler, and can be used in studies for assessment of the pores.

The next step in the validation process involved presenting the images to naive Japanese consumers and having them rank order the images. 55 Japanese consumers (age: 20-55, female) were asked to rank the photographs in increasing order of perceivable pore size. The consumers ranked the images in the same order as the clinicians. There was significant difference for every pair of photos at 95%.

Transformation

To avoid distraction by imperfections unrelated to pores or other facial attributes and to provide equal steps between neighboring images on the scale, the ruler is optionally, but preferably, transformed.

To this end, the images are modified by a method described in Hawkins S. S., et al., “Prototypes of Facial Attributes Developed through Image Averaging Techniques,” Int. J. Cos. Sci. , 21(3):159-166, 1999. Hawkins et al have demonstrated the potential of facial averaging and caricaturing for the development of aging and healthy attribute measurementaxes. These axes could then be used to quantify improvement of treatments from baseline as a whole panel, to demonstrate multiple attributes that change with treatment. The advantages of this technique over other image processing algorithms is that there are no a priori assumptions/constraints on areas or features that improve, and only the important features/sources of variation that are representative of the whole panel will appear in a facial average.

Averaging of shape, color, and texture was computed using a four-step process:

1. Semi-automatic delineation of predefined feature points;

2. Calculation of the average facial shape;

3. Morphing individual images into that shape and blending together;

4. Computing the average texture via wavelets along different coarse to fine scales and transforming onto the average shape and color.

To accurately represent the texture on the face, relevant features, such as pores or fine lines must be characterized for the average face despite variations in:

location on the face

size/scale/frequency

orientation

degrees of random variation.

Wavelet analysis allows to study the variation of images at multiple scales (coarse to fine) and orientations. By adding wavelets as an additional measure to contribute to facial averages and caricatures, the average texture of a whole panel is preserved.

Facial averages for each grade on the ruler were computed by the steps outlined above from individual digital images of each subject. Two-dimensional (2D) facial averaging provides enhanced sensitivity for quantifying improvement via 2D images over current methods of image quantification (where magnitude of improvement is small). For example, if pore attribute, color, shape, and/or texture changes across an entire panel were not consistent, the facial average would tend to blend out an attribute that improved on only a small number of subjects. Conversely, if a pore, color, shape, and/or texture attribute improves on several subjects, the visualization of improvement tends to be enhanced when viewed as an average.

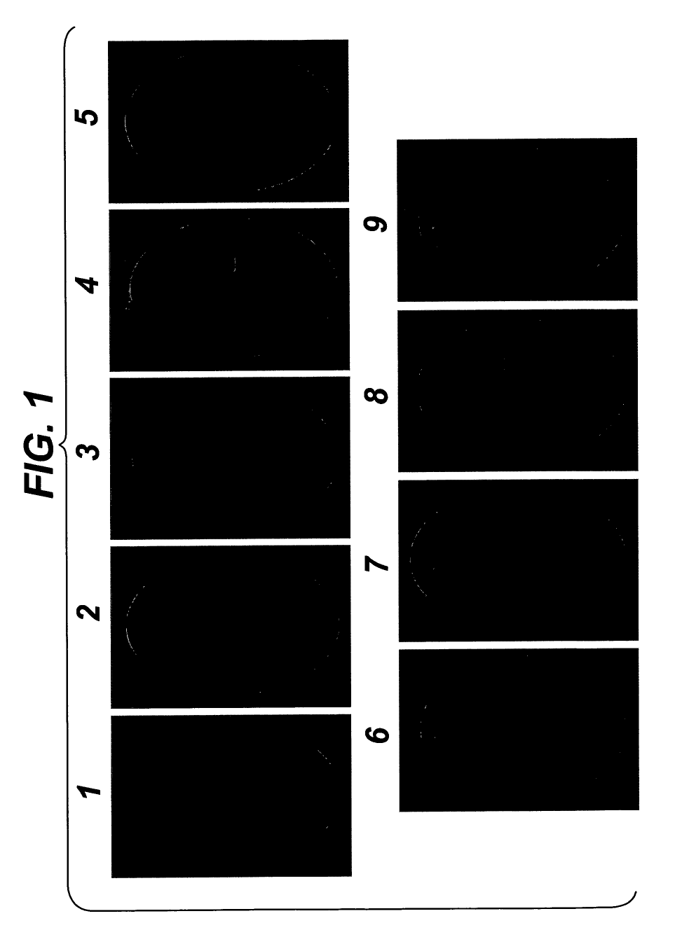

FIG. 1 represents pore ruler scale 10 thereby developed, according to one embodiment of the present invention, having 9 images.

Device

Ruler devices according to the present invention visually assess facial topography in an objective manner. Ruler devices include a scale having indicia of at least two different pore sizes or other facial attributes captured in a medium. Examples of such medium include the Internet, camera, palm pilot, mobile phone, or water-insoluble substrate.

Several possible embodiments of the ruler device having a water-insoluble substrate are as follows.

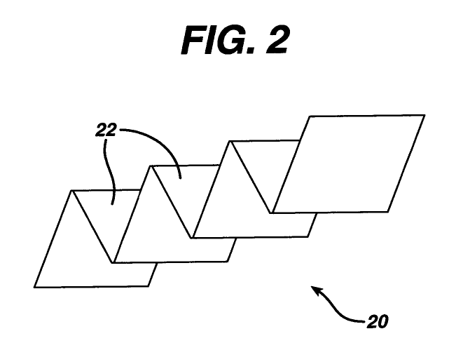

With reference to FIG. 2, in a first embodiment the device according to the present invention, a ruler device 20 is a strip having a plurality of ruler scales 22 represented thereon. Ruler device 20 may be folded into a concertina, or accordion arrangement, for compactness and/or easier insertion onto a package.

With the particular illustrated embodiment, ruler device 20 strips for use with the illustrated embodiment will be articles allowing observation and comparison of the condition of facial skin pores with the ruler scale 22. Suitable materials for the strip are paper, plastics or cellulosics, of any variety thereof which can be formed as transparent films. Typically the plastic may be selected from polyethylene, polypropylene, polystyrene, polyester, polycarbonate, polyacrylate, polyvinyl chloride, polyvinyl alcohol and polybutene. Not only homopolymers but copolymers may be utilized for the strip material. Copolymers may be formed from such monomers as C₂-C₁₀ olefins, vinyl chloride, acrylates and styrene constructed through free-radical polymerization. Condensation plastics may also be utilized in the formation of copolymers wherein the monomers may be selected from C₂-C₁₀ dicarboxylic acids, C₂-C₁₀ polyols, C₂-C₆ alkoxylates and combinations thereof. Polyethylene, polypropylene and polyester terephthalate are the preferred plastic substrates for forming the strip.

The thickness of the strip may range anywhere from about 0.00001 to about 2 mm, preferably from about 0.0001 to about 1 mm, more preferably from about 0.001 to about 0.5 mm and optimally from about 0.01 to about 0.1 mm.

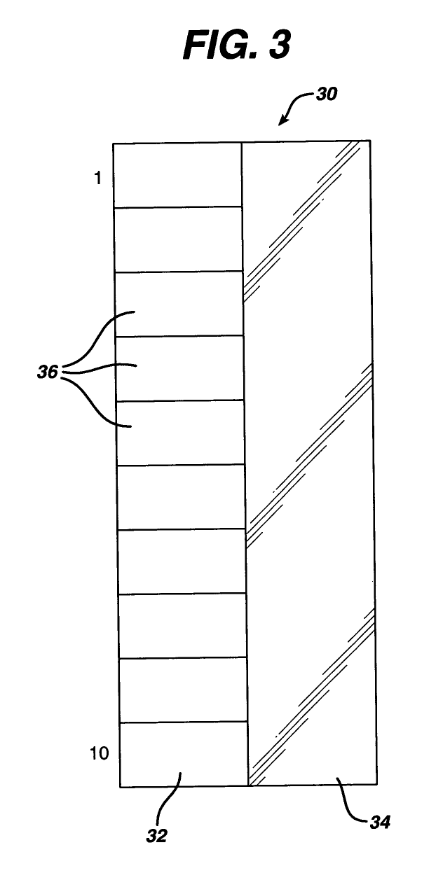

With reference to FIG. 3, in a second embodiment according to the present invention, pore ruler device 30 includes a pore ruler half 32 having a plurality of pore attribute scales 36 and on adjacent other half 34 a transparent material as described above with reference to FIG. 2. Half 34 of device 30 may have a mirrored surface or other reflective surface. In use, a user may place device 30 against her skin and, in the case of transparent half 34, compare her skin to scale 36 while looking in a mirror. In the case of half 34 being a reflective surface, a user may look into the reflective surface and compare her skin in the reflective surface against scale 36.

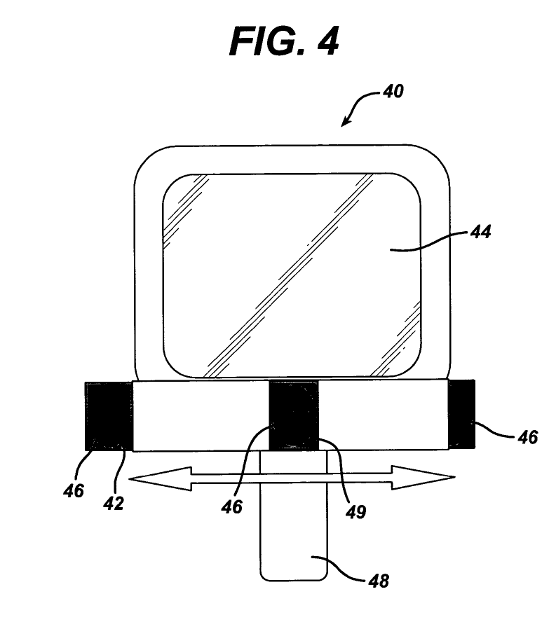

With reference to FIG. 4, in a third embodiment of ruler device 40 according to the present invention, a sliding ruler 42 having a plurality of facial attribute scales 46 is provided in combination with at least one mirror 44. Sliding ruler 42 has a handle 48 and a slit 49 therein. Sliding ruler 42 is attached by handle 48 and positioned adjacent, and in this case, under mirror 44. An image on pore ruler scale 46 can be seen from slit 49 by sliding ruler 42. Sliding ruler 42 may also be positioned in any configuration other than under mirror 42. Additionally, ruler 42 may be semi-transparent and embedded on mirror 44. A user will find an image 46 representative of her condition on ruler 42 by superimposing an area of her skin on scale images 46 on mirror 44.

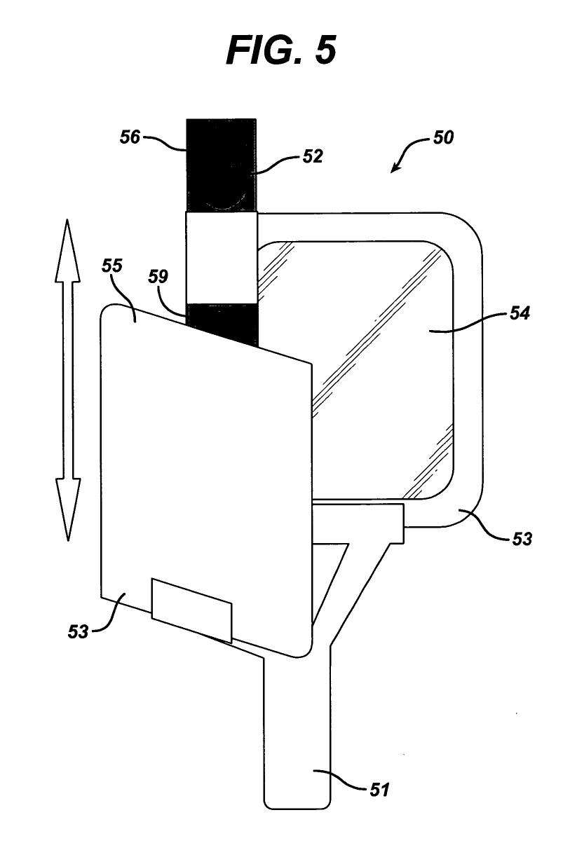

With reference to FIG. 5, in a fourth embodiment of ruler device 50 according to the present invention, a sliding ruler 52 having a plurality of pore attributes on scale 56 is provided in combination with two mirrors 53 positioned at an angle to each other and held on pedestal 51. Each mirror has a reflective mirror surface 54 and a rear mirror portion 55. Sliding ruler 52 has a handle 58 (not shown) having a slit 59 therein. Sliding ruler 52 is attached by handle 58 (not shown) and positioned adjacent one of mirrors 53 and an image on pore ruler scale 56 can be seen from slit 59 by sliding ruler 52. Sliding ruler 52 may also be positioned in any configuration other than adjacent one of mirrors 53. Additionally, ruler 52 may be semi transparent and embedded on one of mirror surfaces 54. A user will find an image on ruler 52 by superimposing an area of their skin on scale images 56 on one or both mirror surfaces 54.

Cosmetic Compositions

Cosmetic compositions of the present invention, such as for reducing the appearance of facial skin pores, wrinkles or other undesired facial atributes, may be in the form of creams, lotions, toners, pastes, sticks (e.g. lipsticks), or powders. These cosmetics normally will include a carrier. Suitable carriers include water, emollients (esters, hydrocarbons, silicones, polyols and mixtures thereof), emulsifiers, thickeners and combinations thereof. Most often the carrier will be an emulsion such as an oil-in-water or water-in-oil type. Amounts of the carrier may range from about 1 to about 99.9% by weight.

Pore reduction active or agents for reducing the appearance of pores may include: astringents, humectants, acne and sebum suppressants, desquamation enhancers, keratolytics, and make-up, among other pore reduction actives known to one skilled in the art.

Astringents

Examples of astringents include, but are not limited to, ethanol, witch hazel, zinc and aluminum salts, and polyphenols.

Humectants

Humectants include propylene glycol (available from Spectrum) glycerol, and sorbitol, among other humectants known to one skilled in the art. Humectants are known as excellent moisturizers for skin, scalp and hair. See for instance U.S. Pat. No. 5,858,340, incorporated by reference herein.

Acne and Sebum Suppressants

Anti-acne actives include benzoyl peroxide and salicylic acid, among other anti-acne agents known to one skilled in the art. Sebum suppressants include compounds of the general formula A:

R—O-M (A)

wherein:

R is a branched alkyl or alkenyl chain having at least 7 carbon atoms, and at least two branches;

O is an oxygen atom; and

M is (—(CH₂)ₚO)ₙ—(CH₂)ₘCO₂X)

where n is 0 or an integer between 1 and 7, m is an integer between 1 and 4, p is an integer between 2 and 4; and X is hydrogen, a methyl group, an ethyl group, or a cation. The cation is selected from the group consisting of sodium, lithium, potassium, calcium, copper, magnesium, manganese, strontium, sulfur, zinc, and amines. Preferably, X is hydrogen or a cation.

Make-Up

Examples of make-up useful for reducing the appearance of pores include foundations, moisturizers, foamers, and concealers, among other make-ups known to one skilled in the art.

Anti-aging actives may include retinoids, ceramides, alpha or beta-hydroxycarboxylic acids, flavonoids, vitamins, sunscreens, anti-oxidants, preservatives and mixtures thereof.

Typical retinoids include retinol, retinoic acid and retinol esters. The latter include retinyl palmitate, retinyl linoleate, retinyl propionate, retinyl acetate and retinyl salicylate.

Alpha-hydroxy acids include the free acid, lactone and salt forms of glycolic acid, lactic acid, citric acid, gluconolactone, glucarolactone, tartaric acid, malic acid and mixtures thereof. Beta-hydroxycarboxylic acids are exemplified by salicylic acid as well as its esters (e.g. tridecylsalicylate) and salts including ammonium, alkanolammonium and alkalimetal salts.

Ceramides include Ceramide 1, Ceramide 2, Ceramide 3, Ceramide 3a, Ceramide 3b, Ceramide 4, Ceramide 5 and Ceramide 6, as well as pseudoceramides, phytosphingosines and tetraacetyl phytosphingosine.

Other skin benefit agents may be included as optional components. Vitamins may include ascorbic acid as well as its water-soluble and water-insoluble derivatives. Illustrative are ascorbyl tetraisopalmitate, magnesium ascorbyl phosphate and ascorbyl glucoside. Other vitamins include Vitamin B3 (niacin, niacinamide and panthenol), biotin, folic acid, tocopherol and its esters (e.g. tocopherol isopalmitate, tocopherol acetate), Vitamin D and combinations thereof.

Antioxidants include BHT (butylated hydroxytoluene), BHA (butylated hydroxyanisole), disodium EDTA (available from Ciba), sodium citrate, hydroquinone, ferulic acid and esters thereof, green tea extract, lipoic acid, N-acetyl cysteine, resveratrol and combinations thereof.

Amounts of the pore or wrinkle reduction or other actives may range anywhere from 0.0000001 to 30%, preferably from 0.0001 to 15%, more preferably from 0.1 to 5%, by weight.

System

Another aspect of the present invention provides a system wherein a cosmetic composition is packaged with a pore ruler device. A variety of packaging arrangements are envisioned. The test device may be incorporated as a panel segment of a carton, the latter protectively surrounding the cosmetic composition. In a variation thereof, the test device may be detachably joined to the package through a perforated or weakened construction line, or through an adhesive joinder.

Methods of Use

The inventive ruler device, system, and methods can be used (1) as a clinical tool to evaluate the efficacy of pore, wrinkle or other undesirable facial attribute reducing products, (2) as a consumer tool to determine the degree of change that is meaningful and ideal to the consumer, (3) as a consumer clinical tool to measure the effectiveness of products from a consumer and clinical perspective, and (4) as a point of purchase device to allow a consumer a simple method to evaluate before and after treatment changes in skin attributes. The ruler provides the ability to define the distribution of facial skin pore or wrinkle size or other attribute in a specific population, set technical and consumer targets, and allows the consumer a simple method to measure the effect.

Specifically, the ruler device may be used for determining the condition of facial skin pre- and post-treatment, or to track changes in pore or wrinkle size, or that of other facial attributes, associated with a variety of factors, such as effects of food, activity, menstrual cycle. Pre-treatment ruler measurements may be used in selecting an appropriate cosmetic product. For example, different product formulations may be recommended depending on the individual pore condition as measured on the pore ruler. Ruler indicia may be printed directly on the package for this purpose, or represented in other media within the scope of the present invention.

Subsequent to a baseline analysis of pores, wrinkles or other facial attributes on the ruler device, treatment is begun with a selected cosmetic product for the particular facial attribute. Treatment is continued for a period of time sufficient to allow the product to treat the signs of the particular facial attribute.

After the treatment period of time, such as four weeks, another ruler measurement is taken. Testing may occur thereafter at 6, 8, 12, 16 and/or 20 weeks. The time intervals and numbers may be longer or shorter. If the cosmetic product is properly functioning, fewer and/or smaller pores, wrinkles or other facial attributes will appear on the ruler device and the ruler score will be lower. This procedure can then be repeated at six or eight weeks or at any further time interval. Each test may employ a fresh ruler device or and new ruler device or ruler medium.

The ruler device may be used in conjunction with a variety of media for displaying of embodying the ruler device, including in or out of home use of strips as described hereinabove, the Internet, webcam, palm pilot, mobile phone, and other media capable of displaying the ruler device. A strip embodying a ruler scale may be given out to consumers at point of sale or at a store display.

The ruler may be used as a clinical tool to support cosmetic product claims on the package. The ruler device provides an objective clinical grading scale, whereby each image is associated with a number.

Except in the operating and comparative examples, or where otherwise explicitly indicated, all numbers in this description indicating amounts of material ought to be understood as modified by the word “about”.

The term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

All parts, percentages and proportions referred to herein and in the appended claims are by weight unless otherwise illustrated.

### EXAMPLE 1

This example illustrates that an evaluation of pre- and post-treatment pore appearance is possible using the pore ruler device scale, suggesting the validity and usefulness of the device and method of the present invention.

An agent for pore size reduction, i.e. a Sheer Coverage foundation available from Calvin Klein Cosmetics Co. Dist., New York, N.Y., was evaluated using a 10 point scale of the pore ruler device. Good results were obtained. Consumers perceived a difference on the pore ruler scale, and the score showed an average improvement from about 6 to about 5 on the 10 point scale.

### EXAMPLE 2

This example illustrates the use of the pore ruler device as a consulting tool at point of purchase. Three different product formulations were available for consumers, depending on their pore ruler measurements. The pore ruler was printed on the package. On a 9 point pore ruler scale, measurements 1-3 represented the best pore condition on the scale and consumers with these conditions would be pointed to the weakest composition for reduction of appearance of pores. Measurements 4-6 represented medium pore conditions and consumers with these conditions would be pointed to a medium strength product. Consumers with the worst pore conditions, with measurements 7-9 on the pore ruler scale, would be pointed to the strongest formulation or regimen for the reduction of appearance of facial pores.

### EXAMPLE 3

This example illustrates the use of the pore ruler for determining the condition of the skin pre- and post-treatment over the Internet. A consumer took a photograph, i.e., electronic image, of her face using a mobile phone with built-in camera, transmitted the electronic image to a Pore Ruler website capable of correlating a given image with those on the pore ruler scale. A pore ruler scale measurement was phoned back to the consumer through the Internet, a measurement of 5 on the pore ruler scale, thereby establishing a pore measurement of the pre-treatment condition.

Subsequently, the consumer applied a PONDS Dramatic Results product over a period of about four weeks. Another electronic photograph was taken using the same mobil phone with built in camera and again transmitted through the Internet. This time the pore ruler measurement transmitted back to the consumer through the Internet measured 3, indicating a significant improvement in appearance of facial pores.

The same procedure may be used using a personal computer with a web camera as an alternative to the mobile phone with built-in camera.

### EXAMPLE 4

Pore ruler device 20 as shown in FIG. 2 was imprinted with images of pore ruler scale 22, folded into a concertina, or pamphlet and placed in a package containing a composition for reducing the appearance of facial pores. For compactness and ease of fit into a package, pore ruler scale 22 consisted of representations of pores on the cheek area.

### EXAMPLE 5

This example demonstrates the utility of the pore ruler scale to define consumer preferences.

During the pore ruler validation study described hereinabove, the consumers were also asked to pick out an image (out of the 9 or 10 images of the ruler) that most represented their current pore condition. They were then asked to pick an image that represented their “ideal” end point from a product as well as what would be an image that they would like to go to with a product in order for them to buy the product. Thus the pore ruler served as a tool to generate purchase intent in consumers.

In this experiment, the subjects choose current, ideal, and product expectation level of pore from the 10 pore ruler photos. The results suggest that consumers' ideal pore condition is almost as low as pore ruler scale 1, which is almost always lower than their current condition on 1-10 scale. The consumers expect a 1 to 7 step improvement from a cosmetic product.

### EXAMPLE 6

This example discusses the use of the ruler in the development and validation of clinical scale and clinical graders for pores.

Based on the learning from the consumer validation study discussed above, two clinicians used the 10 images of the ruler as anchor points and constructed a clinical scale to grade facial pores. This scale had a half point increment between the 10 images of the pore ruler, and hence it was a 19 point grading scale. The 100 images used to generate the ruler were graded by 2 clinicians using the above scale. For the purposes of this exercise, the clinicians concentrated on the cheek area of the images since that was observed to be a big driver for the perception of pores. The results of this exercise showed that the two graders are highly correlated with one another. The pore ruler images were thus used as anchors to generate a reproducible clinical scale for the grading of facial pores.

In a separate exercise, the clinicians verified that there was a high correlation between the grades assigned based on just the cheek area and the global face pore grade.

A one point improvement on the scale was considered to be both noticeable and relevant to the consumer as well as the expert grader.

The foregoing description and examples illustrate selected embodiments of the present invention. In light thereof variations and modifications will be suggested to one skilled in the art, all of which are within the spirit and purview of this invention.

What is claimed is:

1. A facial ruler device comprising a scale having indicia of at least two different facial attributes captured in a medium, wherein said scale is determined by a method comprising the following steps:
(i) Taking multiple photographs of multiple subjects;
(ii) Sorting said photographs, thereby classifying them according to said facial attributes to obtain sorted data;
(iii) Analyzing said sorted data;
(iv) Selecting representative images from each class, thereby creating a facial ruler scale; and
(v) Validating said facial ruler scale by clinicians and consumers to show that consumers can distinguish pore attributes and correlate them with said scale.

2. The ruler device according to claim 1, wherein said medium is selected from the group consisting of Internet, camera, palm pilot, mobile phone, mobile camera phone, water-insoluble substrate and advertising and promotional material selected from the group consisting of television, magazines, brochures, posters, flyers, and hand-outs.

3. The ruler device according to claim 2, wherein said water-insoluble substrate comprises a strip, a double strip, or a sliding ruler alone or in combination with a mirror.

4. The ruler device according to claim 2, wherein said water-insoluble substrate comprises a material selected from a cellulosic, plastic, mirror or combination material.

5. The facial ruler device according to claim 1, wherein said facial ruler represents attributes of pores, wrinkles, photoaging, or skin texture.

6. A cosmetic product system comprising:
(i) a cosmetic composition for reducing the appearance of undesirable facial attributes housed in a package; and
(ii) a facial ruler device associated with said package;
the device having a means for evaluating current appearance of facial attributes or progress in reducing the appearance of facial attributes with the use of said cosmetic composition.

7. The system according to claim 6, wherein said ruler device comprises a scale having indicia of at least two different facial attributes captured in a medium, wherein said scale is determined by a method comprising the following steps:
(i) Taking multiple photographs of multiple subjects;
(ii) Sorting said photographs, thereby classifying them according to said facial attributes to obtain sorted data;
(iii) Analyzing said sorted data;
(iv) Selecting representative images from each class, thereby creating a facial ruler scale; and
(v) Validating said draft ruler by clinicians and consumers to show that consumers can distinguish facial attributes and correlate them with said scale.

8. The system according to claim 6, wherein said media are selected from the group consisting of Internet, camera, palm pilot, mobile phone, water-insoluble substrate.

9. The ruler device according to claim 6, wherein said water-insoluble substrate comprises a strip, a double strip, or sliding ruler.

10. The system according to claim 6, wherein said ruler device comprises a material selected from a cellulosic, plastic, mirror or combination material strip, and the strip is placed into a carton alongside a container holding the cosmetic composition.

11. The system according to claim 6, wherein said ruler device is incorporated as a panel segment of a carton protectively surrounding a container holding the cosmetic composition.

12. The system according to claim 6, wherein said ruler device is detachably joined to a carton protectively surrounding a container holding the cosmetic composition; said joinder of said device being through a means selected from group consisting of perforations, weakened carton wall and adhesive joinder.

13. The cosmetic system according to claim 6, wherein said facial attributes are selected from the group consisting of pores, wrinkles, photoaging, or skin texture.

14. A method for evaluating efficacy of a cosmetic product, the method comprising:
(A) providing a kit which comprises the system according to claim 6;
(B) applying the cosmetic product to the skin;
(C) placing said ruler device against the skin treated with the cosmetic product in step (B);
(D) visually assessing a score on said ruler scale; and
(F) repeating steps (C) and (D) at a future time followed by comparison of scores resultant from first and second assessments of the skin.

15. The method according to claim 14, wherein said evaluation is a self-evaluation by a consumer or an evaluation by a clinician, beautician or sales assistant.

16. The method according to claim 14, wherein said assessments are of facial attributes are selected from the group consisting of pores, wrinkles, photoaging, and skin texture.

17. A method of evaluating facial attributes on an area of human skin comprising:
(A) providing a pore ruler device according to claim 1;
(B) comparing said area of skin with said indicia on said ruler scale to categorize said area of skin on said scale.

18. The method according to claim 17, further comprising placing said ruler against the skin prior to said product application.

19. The method according to claim 17, wherein said facial attributes are selected from the group consisting of pores, wrinkles, photoaging, and skin texture.
